(19) United States
(12) Patent Application Publication
(10) Pub. No.: US 2026/0030289 A1
(43) Pub. Date: Jan. 29, 2026

(54) CUSTOM METADATA GENERATION FOR DIGITAL ASSET SEARCH USING MACHINE LEARNING

(71) Applicant: NVIDIA Corporation, Santa Clara, CA (US)

(72) Inventor: Nikola SPASOJEVIC, Santa Clara, CA (US)

(21) Appl. No.: 19/281,298

(22) Filed: Jul. 25, 2025

Related U.S. Application Data
(60) Provisional application No. 63/676,425, filed on Jul. 28, 2024.

(51) Int. Cl. G06F 16/535; G06F 16/538

(52) U.S. Cl. CPC G06F 16/535; G06F 16/538

(57) ABSTRACT

Embodiments of the present disclosure relate to AI-based metadata generation for digital asset search. In operation, some embodiments first receive a prompt requesting one or metadata attribute values to be associated with a digital asset. Some embodiments then generate a response to the prompt based at least on a model processing a representation of the prompt and a representation of the digital asset. The response includes one or more metadata attribute values of the digital asset. After the response is generated, some embodiments then store the response using an index. The index is configured to facilitate retrieval of the digital asset as a search result candidate. Various embodiments of the present disclosure have various technical effects and benefits relative to existing technologies, such as improved computer search accuracy, significant reduction in the need for manual tagging, flexibility, scalability, and variability, among others.

### CROSS-REFERENCE TO RELATED APPLICATIONS

This application claims the benefit of U.S. Provisional Application No. 63/676,425, entitled “Artificial Intelligence Agentic Systems for Multi-Modal Asset Search, Scene Understanding, and Automated Scene Validation for Synthetically Generated Content,” filed on Jul. 28, 2024, the entirety of which is incorporated herein by reference.

### BACKGROUND

Digital asset management refers to the processes and tools used to store, organize, and retrieve digital assets (e.g., a 3D model of a virtual object) and related data. This functionality is fundamental in industries such as simulation, gaming, virtual reality (VR), film, architecture, and product design. These technologies are designed to help users efficiently curate and manage collections of digital assets, ensuring that digital assets can be easily accessed, reused, and incorporated into various projects or workflows.

Metadata generation plays a crucial role in digital asset management. Metadata generation involves creating descriptive and/or parametric information about digital assets, which helps make the digital assets more searchable and discoverable. Such metadata includes attributes like the color of digital assets, names of digital assets, and use context, allowing users to filter and locate specific assets efficiently. However, current metadata generation methods face significant technical challenges. For example, they often rely on manual user input or crowdsourcing, and they miss context-specific details, which can lead to inconsistent, incomplete, or erroneous data, thereby limiting the effectiveness and accuracy of searches.

### SUMMARY

Embodiments of the present disclosure relate to AI-based metadata generation for digital asset search. In operation, some embodiments first receive a prompt requesting one or more metadata attribute values to be associated with (e.g., as a searchable reference to) a digital asset. For example, a user may first upload a YAML Ain′t Markup Language (YAML) configuration file that defines metadata attributes the user wants the system to search for in an pre-existing 3D digital asset. Alternatively or additionally, the configuration file could define other attributes (e.g., return types of the metadata, such as the text caption being represented as a string, colors being represented as a list of strings, or materials being represented as a list of strings). The YAML file acts as the source of the “prompts,” specifying the attributes and, optionally, providing descriptions for how those attributes should be detected (e.g., “Identify the materials used in the asset.”).

Some embodiments then generate a response to the prompt based at least on a model processing a representation (e.g., a vector embedding and/or natural language characters) of the prompt and a representation of the digital asset. The response includes one or more metadata attribute values of the digital asset. For example, an input to a multi-modal model may be the prompt and a representation of a digital asset (e.g., images of a 3D chair rendered from multiple angles). The multi-modal model processes the rendered images of the chair and combines them with the prompt. The multi-modal model detects relevant details (e.g., the chair's material) based on visual and contextual cues. The output or response may be, for example, JavaScript Object Notation (JSON) code such as {“material”: [“wood”, “fabric”]}. This response maps the extracted metadata attribute values (“wood” and “fabric”) to the requested attribute (“material”), completing the process.

After the response is generated, some embodiments then store the response using an index. The index is configured to facilitate retrieval of the digital asset as a search result candidate. The index associates these metadata values with a unique identifier for the digital asset (e.g., file path, asset ID, or URL). This association allows the system to efficiently match user search queries against the metadata in the index and retrieve the corresponding digital asset as a search result candidate. By storing the metadata in an index, embodiments are able to filter the results from original semantic (CLIP embedding) search results using keyword matching and/or combine the score of the keyword matching with the score of the semantic search to improve accuracy.

Various embodiments of the present disclosure have various technical effects and benefits relative to existing technologies, such as improved computer search accuracy, significant reduction in the need for manual tagging, flexibility, scalability, and variability, among others.

### BRIEF DESCRIPTION OF THE DRAWINGS

The present systems and methods are described in detail below with reference to the attached drawing figures, wherein:

FIG. 1 illustrates an example indexing pipeline, according to some embodiments;

FIG. 2 illustrates an example search pipeline, according to some embodiments;

FIG. 3 is a schematic diagram illustrating the contents of a YAML file, according to some embodiments;

FIG. 4 is a schematic diagram of extracted metadata attribute-value pairs, according to some embodiments;

FIG. 5 is a screenshot of an example user interface page illustrating digital asset search results that are surfaced in response to processing a query, according to some embodiments;

FIG. 6 is a block diagram illustrating how a metadata index is re-indexed, according to some embodiments;

FIG. 7 is a flow diagram of an example process for building a metadata index that describes attribute value(s) of a digital asset, according to some embodiments;

FIG. 8 is a flow diagram of an example of a search process for executing a user query that references attribute value(s) of a digital asset, according to some embodiments;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

Existing digital asset management technologies often depend on manual input for metadata generation, where creators or asset managers must individually tag and describe digital assets. This method is highly labor-intensive and prone to inconsistencies and human error, as the accuracy and completeness of the metadata has typically relied on the thoroughness and expertise of the person performing the task. The result is often incomplete or incorrect metadata, which makes it difficult for users to find the specific assets they need. For example, digital assets like a chair or a table need to be manually labeled by users as such. If a labeler uses even slightly different terms for the same asset or makes mistakes when labeling, those assets might not be retrieved in a search, thereby making search retrieval inaccurate and/or incomplete. This limits the scope of search queries to only pre-tagged labels, reducing flexibility and search complexity. Complex relationships and multimodal aspects (like geometry, materials, lighting conditions) are often not tagged or cannot be manually tagged efficiently by individuals.

While crowdsourcing can provide a wider range of perspectives by allowing multiple users to tag and describe digital assets, crowdsourced labeling typically results in inconsistent and variable-quality metadata. Different users may use conflicting terminology or apply tags inconsistently, creating metadata that lacks uniformity. This lack of standardization can lead to challenges in digital asset retrieval, as search systems may struggle to interpret and match user queries with the varied and sometimes contradictory metadata generated by crowdsourced input.

Digital asset management technologies that use machine learning models for semantic search typically fail to capture context-specific details that are essential for accurate and useful metadata. For example, existing Contrastive Language-Image Pre-training (CLIP) models identify general characteristics of an asset (e.g., a 3D model being a “car”) but miss finer distinctions such as specific materials, interior features, or subcategories like “convertible” versus “sedan.” This lack of nuanced information means that search results can be generic and lack sufficient context or granularity to meet users' precise needs, forcing them to conduct time-consuming manual searches or modify queries to compensate for the limited metadata.

Various embodiments of the present disclosure employ one or more technical solutions that solve one or more of the technical problems described above and other technical problems. Various aspects are directed to AI-based metadata generation for digital asset search. In operation, some embodiments first receive one or more prompts requesting one or more metadata attribute values to be associated with the digital asset, to allow the digital asset to be searched for with reference to the one or more attribute values. For example, a user may first upload a YAML Ain′t Markup Language (YAML) configuration file that defines metadata attributes they want the system to search for in a set of 3D digital assets and/or other attributes (e.g., return types of the metadata, such as the text caption being represented as a string, colors being represented as a list of strings, or materials being represented as a list of strings). The YAML file acts as the source of the “prompts,” specifying the attributes and, optionally, providing descriptions for how those attributes should be detected. In an example scenario, a user working with furniture assets adds a field in the YAML file for “material,” and provides a description: “Identify materials like wood, metal, or fabric used in the object.” A YAML file is a human-readable data serialization that may be used for configuration files and data storage. The return types metadata ensure that the system structures the metadata consistently, allowing for seamless integration with downstream processes. For example, a text caption is defined as a string to store a single descriptive sentence, colors are defined as a list of strings to represent multiple color values, and materials are defined as a list of strings to capture various material types. By specifying the return types, the system validates and formats the metadata correctly before storing the metadata in the index, ensuring consistency across different assets and query results.

Some embodiments then generate a response to the one or more prompts based at least on a model (e.g., a multi-modal model) processing a representation (e.g., a vector embedding and/or natural language characters) of the one or more prompts and a representation of the digital asset. The response includes one or more metadata attribute values of the digital asset. For example, an input to a multi-modal model may be the prompt (e.g., “Identify the materials used in the asset”) and a representation of a digital asset (e.g., images of a 3D chair rendered from multiple angles). The multi-modal model processes the rendered images of the chair and combines them with the prompt. The multi-modal model detects relevant details (e.g., the chair's material) based on visual and contextual cues. The output or response may be, for example, json code such as {“material”: [“wood”, “fabric”]}. This response maps the extracted metadata attribute values (“wood” and “fabric”) to the requested attribute (“material”), completing the process.

In some embodiments, the model generates embeddings for both the images and the text prompt, aligning them in a shared semantic space to identify features in the images that match the requested metadata attribute. To format the output (e.g., {“material”: [“wood”, “fabric”]}), some embodiments use output parsing mechanisms where the text prompt specifies the required structure. For example, the model is instructed to output results in a key-value format where the key is the metadata attribute (“material”) and the value is a list of detected items (e.g., “wood,” “fabric”). If the output does not conform to the required structure, the system validates and retries until the output meets the desired format.

After the response is generated, some embodiments then store the response using an index. The index is configured to facilitate retrieval of the digital asset as a search result candidate. The index is configured to associate these metadata values with a unique identifier for the digital asset (e.g., file path, asset ID, or URL). This association allows the system to efficiently match user search queries against the metadata in the index and retrieve the corresponding digital asset as a search result candidate. The index facilitates this process by organizing the metadata in a structured and searchable format, enabling fast retrieval based on attributes like color, material, or context. In some embodiments, the digital asset itself is not stored in the index; only its metadata and identifier are stored to ensure scalability and efficiency.

In an illustrative example, the following response metadata may be stored in the index: {“color”: [“brown”], “material”: [“wood”, “fabric”], “scene_type”: “living room”}. Various embodiments store this metadata in the index, associating the metadata with the unique identifier for the digital asset (e.g., asset 123). A user may then search for “brown wooden furniture.” The system searches the index, matches (e.g., via Natural Language Processing (NLP)) the query to the metadata, and identifies asset 123 as a relevant candidate. Using the identifier (asset 123), the system retrieves the corresponding digital asset (e.g., a 3D chair model) from its original storage location and presents the digital asset to the user as a search result. This step ensures that metadata-driven searches are accurate and efficient, enabling the system to find and retrieve digital assets quickly based on user queries.

By storing the metadata in an index, embodiments are able to filter the results from a set of original semantic (CLIP embedding) search results using keyword matching and/or combine the score of the keyword matching with the score of the semantic search to improve accuracy. During a search, in some embodiments the system first performs a semantic search by converting the user query and the indexed metadata (captions, descriptions, etc.) into embeddings and calculating a similarity score (e.g., cosine similarity). Simultaneously, in some embodiments the system performs keyword matching on indexed metadata attributes (e.g., tags, materials, colors) to identify exact or partial matches. The final search score can be obtained by combining the semantic similarity score with the keyword match score using a weighted sum or another aggregation function. This hybrid approach filters out irrelevant results and ranks relevant assets higher, improving search precision.

Various embodiments of the present disclosure have various technical effects and benefits relative to existing technologies. For example, various embodiments automate the generation of metadata using one or more multi-modal models (e.g., Llama 3.2 Vision, NVIDIA's VILA, visualGPT, or VILBERT (VisualBERT)) that process both visual and textual information. By rendering 3D assets (e.g., from multiple angles) and analyzing these images, these models can automatically extract detailed attributes such as colors, materials, and specific features. This significantly reduces the need for manual tagging, ensuring more consistent and complete metadata without relying on human input. Additionally, the ability to define custom metadata fields (e.g., using a YAML configuration) means that users can tailor the process to their needs while still benefiting from automation, allowing for flexible and scalable metadata generation.

To overcome the inconsistencies inherent in crowdsourced metadata, some embodiments provides an automated and uniform approach to generating metadata, thereby ensuring a higher level of consistency across all assets. By leveraging multi-modal models, the system standardizes the interpretation and tagging of assets, avoiding the varied terminology and quality issues found in crowdsourced solutions. In some embodiments, the model processes assets based on predefined or user-specified fields, creating a structured, reliable output that aligns with uniform metadata standards. This eliminates the variability associated with human crowdsourcing and provides a stable, reproducible source of metadata.

Various embodiments addresses the shortcomings of machine learning models that miss context-specific details by allowing users to define custom metadata fields that focus on particular attributes of interest. For example, by using a YAML configuration, a user can specify detailed fields such as “interior material” or “car type,” prompting the multi-modal model to extract these specifics from the rendered images. The system's capacity to handle both textual and visual data ensures that metadata captures nuanced, context-relevant information, overcoming the generic output typical of existing models like CLIP. This capability improves the search accuracy of producing search results, enabling users to find assets with precise characteristics without additional manual search adjustments.

### Example Digital Asset Retrieval System

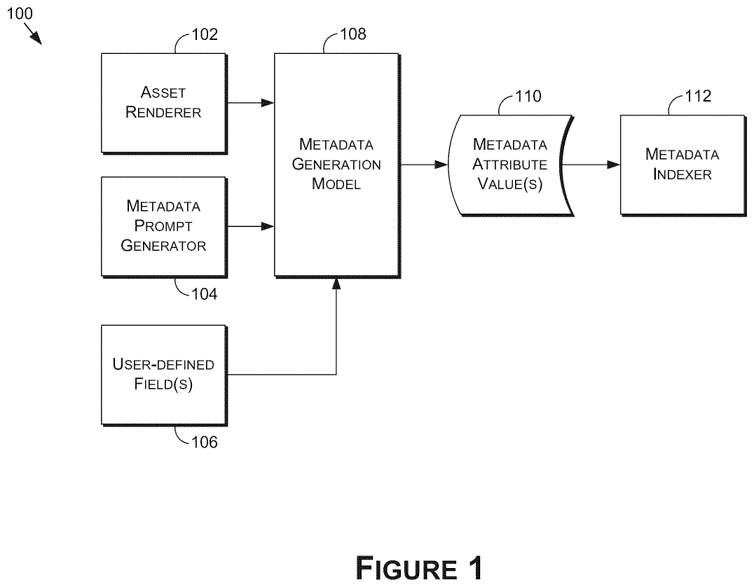

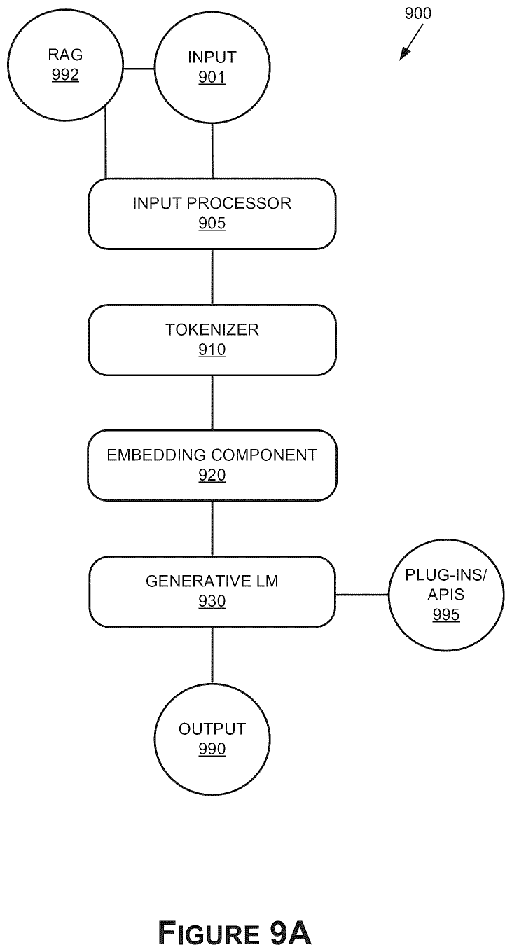

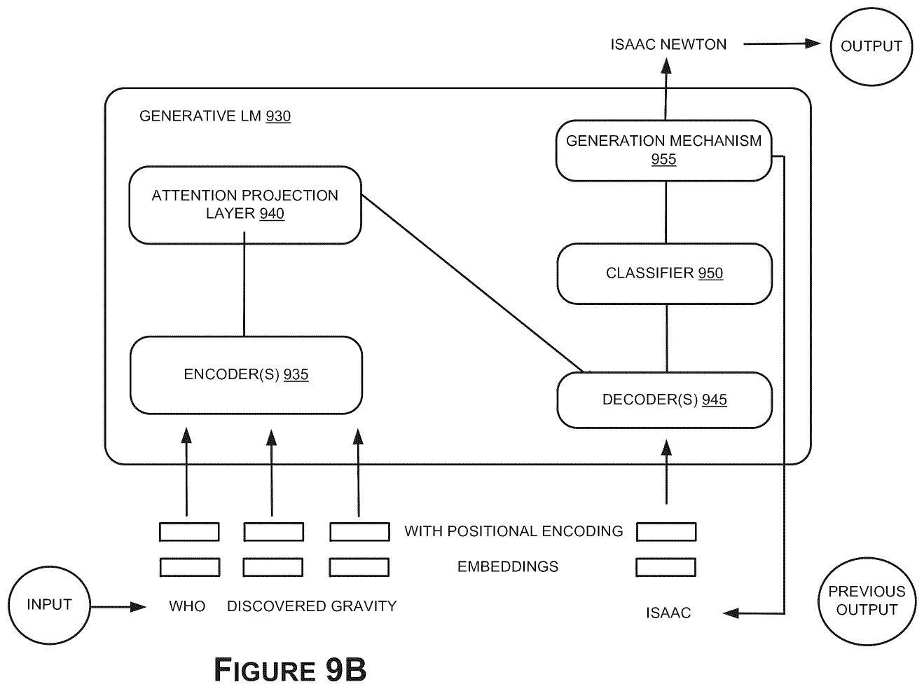

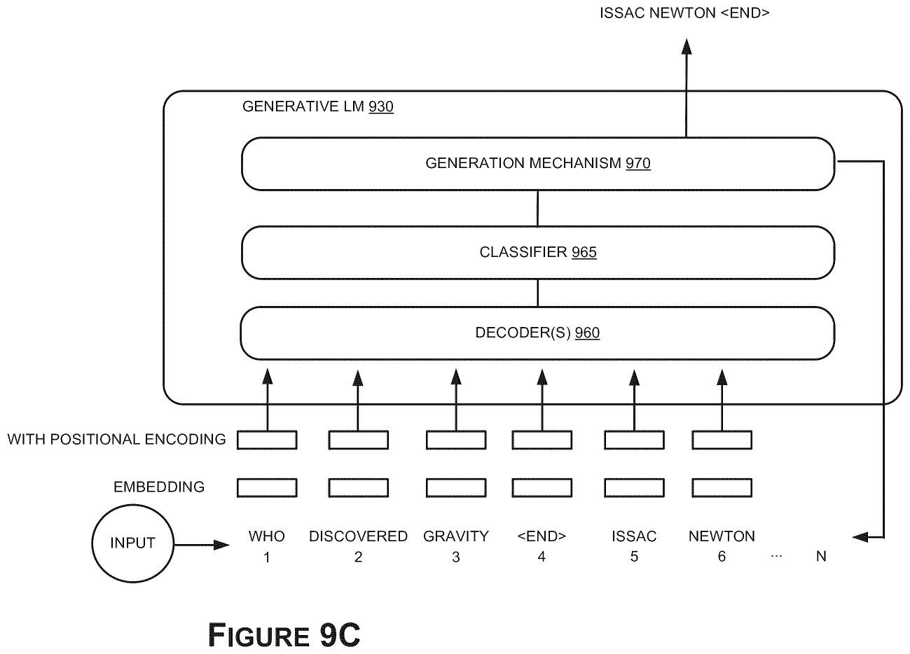

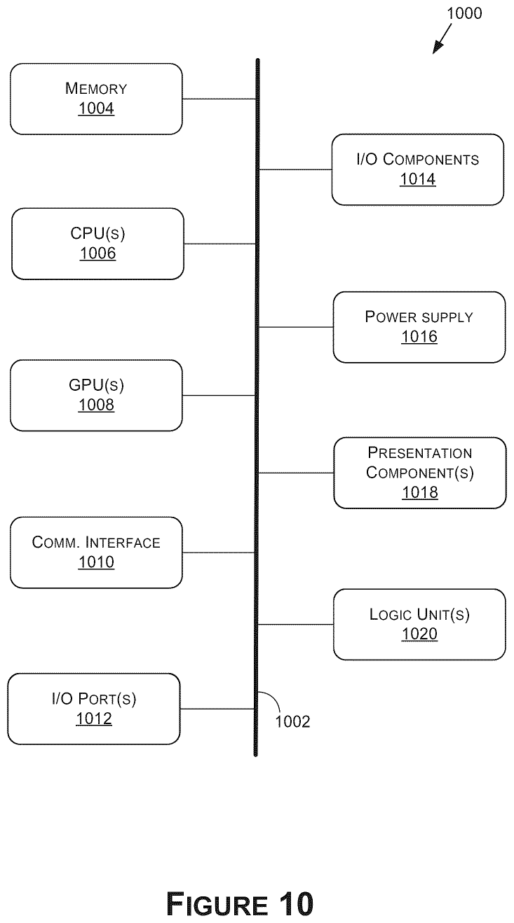

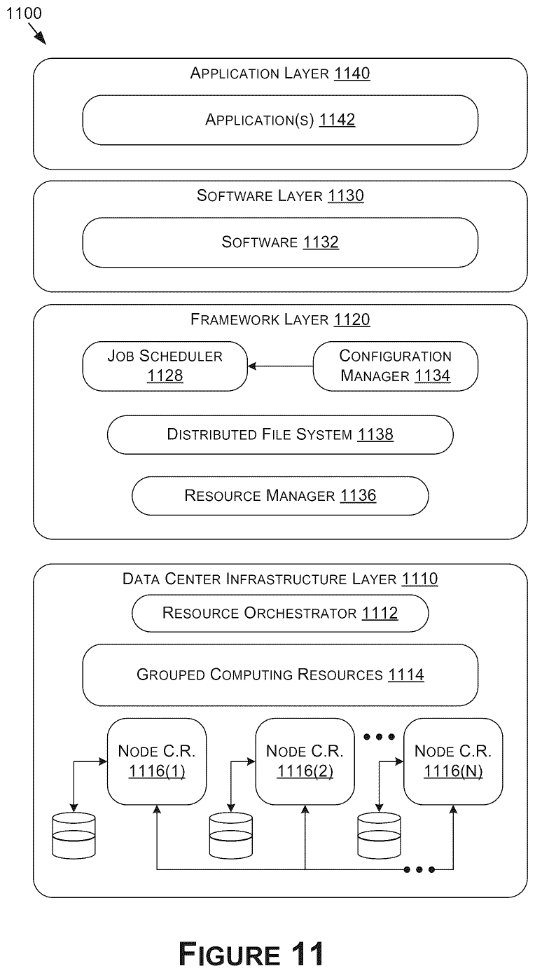

With reference to FIG. 1, FIG. 1 illustrates an example indexing pipeline (referred to as “pipeline 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the system and methods described herein (e.g., the pipeline 100 or the processes 700 and 800) may be implemented using one or more generative language models (e.g., as described in FIGS. 9A-9C), one or more computing devices or components thereof (e.g., as described in FIG. 10), and/or one or more data centers or components thereof (e.g., as described in FIG. 11).

As a high level overview, the pipeline 100 is operable to build an index using the metadata attribute value(s) 110. The pipeline 100 includes an asset renderer 102, a metadata prompt generator 104, one or more user-defined fields 106, a metadata generation model 108, one or more metadata attribute values 110, and a metadata indexer 112.

The asset renderer 102 processes a digital asset (e.g., a 3D digital asset) to generate a visual representation. In some embodiments, the asset renderer 102 represents a rendering service (e.g., Kit-Based) that processes and converts USD files into visual outputs (like images, thumbnails, or renderings). For example, the rendering service processes and converts USD files by utilizing a rendering engine that interprets the 3D scene data, including geometry, textures, materials, lighting, and camera settings, embedded in the USD file. When a USD file is passed to the service, the service reads the file's scene graph, which defines the spatial relationships between objects, and applies the defined materials and textures. The rendering engine then simulates lighting and shading based on the scene's parameters and generates a visual output, such as an image or thumbnail. The result is a rendered 2D representation of the 3D asset, which can be used for display in user interfaces or further processing in search and indexing pipelines.

In some embodiments, the asset renderer 102 uses a combination of models and functions, including ray tracing algorithms, path tracing for realistic lighting simulations, rasterization for real-time rendering, and/or physically-based rendering (PBR) models to simulate materials accurately. In some embodiments, the asset renderer 102 leverages illumination models (e.g., Phong or Blinn-Phong) to determine how light interacts with surfaces, and global illumination techniques to simulate light bouncing across objects. Advanced rendering services may also incorporate machine learning models to enhance image quality through denoising or optimize rendering speeds using neural networks. For GPU-accelerated tasks, frameworks like CUDA or OptiX may be used to offload heavy computations, while functions such as culling and level of detail (LOD) management ensure efficient processing of complex scenes by rendering only visible elements.

In some embodiments, the output of the asset renderer 102 includes a series of images rendered from multiple angles. These rendered images provide the necessary input for the metadata generation model 108 to analyze and extract relevant details. For example, a user uploads a 3D model of a chair. The asset renderer 102 generates images of the chair from the front, back, side, and top views, ensuring all visual aspects (e.g., shape, color, and material) are captured. The output is a set of rendered images such as: Image 1: Front view (brown chair with fabric seat), Image 2: Side view (wooden legs visible), Image 3: Top view (rounded backrest).

In some embodiments, a digital asset, such as a 3D asset is represented as a collection of geometric data (e.g., vertices, edges, and faces forming a polygonal mesh), along with material properties (e.g., colors, textures, and reflectivity) and lighting information. To generate one or more images of the digital asset, in some embodiments the asset renderer 102 simulates a virtual camera that captures the digital asset from one or more perspectives (e.g., multiple different perspectives). The camera's intrinsic parameters (e.g., focal length, field of view) define how the 3D scene is projected onto the 2D image plane. The camera's extrinsic parameters (e.g., position, orientation) specify the viewpoints, ensuring that the asset is rendered from multiple angles in some embodiments.

In some embodiments, the projection from a 3D asset to 2D is mathematically represented as: P=K·[RIT]·M, where P is the 2D projection of the 3D points, K is the camera intrinsic matrix (e.g., focal length, principal point), [RIT] is the camera extrinsic matrix (rotation RRR and translation TTT), and M is the 3D model's vertices in world coordinates.

In some embodiments, the asset renderer 102 applies lighting models (e.g., the Phong reflection model) to simulate how light interacts with the asset's surface. This includes, for example, diffuse shading (models how light scatters off a rough surface), specular reflection (simulates shiny reflections from polished surfaces), and/or ambient lighting (adds uniform lighting to simulate indirect light). In some embodiments, light transport models such as ray tracing can be used by the asset renderer 102 to generate the visual representation(s) of the digital asset. Ray tracing is a rendering technique that simulates the behavior of light as it interacts with objects in a scene, producing realistic visual representations. Ray tracing traces the path of individual light rays as they travel from the camera into the scene. Rays may interact with objects by reflection (bouncing off reflective surfaces like metal or mirrors), refraction (passing through transparent materials like glass or water), and/or absorption (being absorbed by matte or opaque surfaces). Ray tracing models how light energy flows through a scene. The outgoing light is seen at a point on a surface is made up of two parts: (1) light emitted by the surface itself if the surface is a light source, and (2) light reflected by the surface. The light reflected by the surface depends on: how much light is coming into the surface, how the surface reflects light (based on its material properties), and the angle at which the incoming light hits the surface. To calculate the total reflected light, the various embodiments consider all possible incoming directions and sums their contributions.

In some embodiments, the asset renderer 102 additionally or alternatively maps material properties (e.g., roughness, metallicity) and textures onto the 3D geometry. Texture mapping applies 2D images (e.g., wood grain) onto the 3D model surface using UV mapping, which assigns texture coordinates to vertices. For example, for a given vertex at 3D position M(x,y,z), the texture coordinate (u,v) is calculated as: (u,v)=f(x,y,z,UV mapping rules). In some embodiments, the asset renderer 102 samples the texture image at (u,v) to color the corresponding pixel. In some embodiments, the asset renderer 102 converts the 3D geometry into a 2D image through a process called rasterization. This maps the 3D vertices to 2D screen space using the camera projection matrix. Clipping discards parts of the geometry outside the camera's view frustum. Rasterization divides the projected geometry into pixels and computes their color and depth values. For each pixel, in some embodiments the renderer 102 computes the depth z to ensure that only the closest geometry is rendered. The final step generates 2D images of the asset by combining the projected geometry, lighting effects, and texture mapping. These images represent the asset as viewed from the selected camera angles. For example, for a chair, the output images might include: a front view showing the seat and backrest, a side view highlighting the wooden legs, and a top view showing the cushion and seat shape.

The metadata prompt generator 104 creates specific textual prompts that guide the metadata generation model 108 to generate the metadata attribute value(s) 110. These prompts define what attributes and values the system should extract from the digital asset, such as “Identify the color” or “Specify the materials.” In an illustrative example, a YAML configuration file is provided by the user to define desired metadata fields:-name: color, description: “Identify all colors present in the asset.”-name: material, description: “Describe the materials used in the asset.” Accordingly, the output includes text prompts such as: Prompt 1: “Identify all colors present in the asset.” And Prompt 2: “Describe the materials used in the asset.”

In some embodiments, the prompts created by the metadata prompt generator 104 is generated by an AI-agent. In some embodiments, this is done using natural language generation (NLG) techniques or pre-trained language models. For example, the AI agent receives contextual information about the digital asset or the user's needs. This can include: the type of asset (e.g., 3D model of a chair), Metadata fields 106 or categories requested by the user (e.g., “color,” “material”), and/or predefined taxonomies or categories from a YAML configuration or asset library. The AI agent uses language models (e.g., GPT-4, T5, or BLOOM) to generate prompts based on the input context. These prompts are phrased as natural language instructions for extracting metadata, ensuring they are clear and tailored to the specific field.

In an illustrative example, if a user provides a YAML file, the AI agent parses the YAML file to extract the required fields and their descriptions. In some embodiments, the AI agent also analyzes the digital asset type (e.g., “chair”) and determine which metadata fields are likely to be relevant (e.g., “color,” “material”). The AI agent uses a language model to turn the input information into natural language prompts. In some embodiments, the AI agent uses predefined templates for common metadata fields or dynamically generate descriptions. For example, for the field “color,” the AI agent generates: “Identify all colors present in the asset.” For the field “material,” the AI agent generates: “Describe the materials used in the asset, such as wood or fabric.” For the field “scene_type,” the AI agent generates: “Classify the typical context or setting where this asset would be used (e.g., living room, office).”

In some embodiments, the AI agent works as a metadata assistant, where the user specifies a set of desired metadata fields for a library of 3D assets. The AI agent dynamically generates descriptive prompts for each field based on the user's inputs and the asset type. In an example interaction, the user input may first be “I want metadata for colors, materials, and intended usage context.” The AI agent may responsively generate prompts, such as “Identify all colors visible on the asset.” “Detect the materials used in the asset and provide details (e.g., wood, metal, fabric).” And “Determine the scene type where this asset is typically used.”

In particular embodiments where AI agents are used, these agents are trained, prompt-engineered, fine-tuned, and/or prompt-tuned to create appropriate prompts. For example, some embodiments use large pre-trained models like GPT-4, T5, or BLOOM for natural language generation of prompts. Particular embodiments then perform few-shot learning by providing a few examples of well-written prompts to the model so that the model learns to generate similar prompts dynamically. Some embodiments, fine-tune a language model on domain-specific data (e.g., prompts for 3D asset metadata) to improve relevance and accuracy. Some embodiments perform template-based prompting, which uses predefined templates for common fields like “color” or “material,” then adjust dynamically based on user input.

In some embodiments, the prompts generated by the metadata prompt generator 104 are alternatively or additionally created by human users. By leveraging a simple interface or configuration file, this allows users to define what metadata attributes they want to extract and how the system should approach the task. Here's how this process could work. For example, a human user can create a YAML or plain text file that specifies the desired metadata fields along with their descriptions or instructions. This file acts as a blueprint for generating the text prompts, with the user manually defining what the system should focus on. For instance, the user specifies three fields: color, material, and scene type. For each field, the user provides a natural language description of what the system should extract, effectively creating the text prompts manually. In some embodiments, a user can start with a predefined library of common prompts for standard metadata fields and then modify them to suit their needs. For example, the predefined text may be “Identify the colors present in the asset.” Users may be able to modify to: “Identify the primary and secondary colors in the asset, focusing on shades of blue or red.” For technical users, prompts can be defined directly within code or scripts that interact with the metadata generation system. For example, a script can include the following:

```
prompts = {
    “color”: “Identify all dominant colors present
    in the digital asset.”,
    “material”: “List the materials used in the asset.”,
  “scene_type”: “Determine the most likely context where
  this asset would be used.”
}
```

In an illustrative example of a user-created prompt, a designer wants metadata for a library of furniture assets, focusing on color, material, and room type. The designer writes a YAML file: fields:

```
  - name: color
      description: “Identify the primary and secondary
      colors of the furniture.”
  - name: material
    description: “List the materials used in the furniture,
    such as wood, metal, or
leather.”
- name: room_type
      description: “Classify the room type where this
      furniture is commonly used (e.g.,
living room, dining room).”
```

The YAML file is uploaded to the metadata generation system. The metadata generation model 108 uses these prompts to extract and generate metadata for each asset.

The user-defined field(s) 106 allows users to specify custom metadata attributes and values that the system should extract. These fields can be tailored to suit particular needs, ensuring the metadata generation aligns with specific use cases or contexts. For example, a game developer might define a custom field for “scene type” to categorize assets by their intended usage environment: YAML Input: fields:

```
  - name: scene_type
    description: “Classify the typical context or setting
    for this asset (e.g., living room,
office)”
```

where the output of the user-defined field(s) 106 is a metadata field like “scene_type”: “living room.” User-defined fields are the metadata categories or attributes that a user wants to extract from the digital asset. They define what metadata the system should generate (e.g., “color,” “material,” “scene_type”). The purpose is to specify the types of metadata attributes that are important to the user. But they do not describe how the system should extract the values (which prompts do). Prompts are textual instructions or queries that describe how the system should process the digital asset to extract the metadata values for a given field. They provide detailed guidance to the system. In some embodiments, prompts guide the metadata generation process by describing what information the system should extract for each user-defined field. For example, for the user defined field of “color” the prompt may be to “Identify all dominant colors present in the digital asset.” In other words, for the user-defined field(s) 106, the user specifies the broad categories they want to generate metadata for (e.g., “color,” “material”). In some embodiments, for each such field, a prompt is created by the metadata prompt generator 104 to provide detailed instructions about what the system should look for and how to extract the relevant metadata attribute values. In some embodiments, the pipeline 100 uses either the metadata prompt generator 104 or the user-defined field(s) 106 but not both.

The metadata generation model 108 (a multi-modal model (e.g., CLIP, BLIP)) is a statistical and/or machine learning model that processes the rendered images of the digital asset in conjunction with the prompts to extract metadata attribute value(s) 110. The metadata generation model 108 aligns visual and textual data to generate context-specific and detailed metadata. For example, for a chair with the following inputs: (1) Rendered images (showing a brown chair with fabric seat and wooden legs); and (2) a Prompt: “Identify all colors present in the asset,” the model 108 outputs: “color”: [“brown”, “beige”] “material”: [“wood”, “fabric”].

The metadata generation model 108 receives one or more of the three key inputs, (1) a rendered digital asset from the asset renderer 102 (e.g., images of the 3D digital asset generated from multiple camera angles). One or more of these images are fed into the visual processing pipeline of the model; (2) user-defined field(s) 106; and (3) the prompt from the metadata prompt generator 104. For each user-defined field, a textual instruction/prompt is provided to guide the model 108 on what metadata to extract. In some embodiments, prompts are derived from the descriptions in the YAML file (e.g., “Identify all dominant colors present in the asset”).

In some embodiments, before feeding the inputs into the metadata generation model 108, various embodiments perform the following preprocessing steps. Some embodiments parse the YAML file to extract the user-defined fields and associated descriptions, which are converted into text prompts. For example, the user defined fields may be “color” and “material” and the descriptions may be, “Identify all dominant colors present in the asset” and “Describe the materials used in the asset.” The rendered images are pre-processed for the model. Some embodiments, for example, resize the rendered images to a fixed resolution (e.g., 224×224 pixels). Some embodiments normalize to scale pixel values to a range suitable for the model (e.g., [0,1] or [−1,1]). Some embodiments additionally or alternatively Augment (if needed) the rendered image(s) to improve robustness (e.g., cropping, rotation).

In some embodiments, the preprocessing includes tokenization. Text prompts are tokenized into numerical representations (e.g., word embeddings) that the model can process. Tokenization may involve breaking the prompt into sub words (e.g., using BERT or GPT tokenizers) and converting them into embeddings. The model 108 processes the visual and textual inputs in parallel, aligning them in a shared semantic space to generate metadata attribute values. With respect to visual processing, the rendered images are passed through a vision encoder (e.g., ResNet, Vision Transformer). The encoder extracts visual features from the images, producing a dense vector representation of the asset. With respect to textual processing, the tokenized prompts are passed through a language encoder (e.g., BERT, GPT). The encoder generates textual embeddings for the prompts, capturing their semantic meaning. A multi-modal embedding space aligns the visual and textual representations. For example, the visual feature vector of the asset (e.g., brown chair) is aligned with the text embedding of the prompt (“Identify all dominant colors present in the asset”). This alignment allows the model 108 to associate specific visual features with the requested metadata attributes.

In some embodiments, the model 108 uses the aligned embeddings to extract the requested metadata attribute values. For example, for “color” the model 108 identifies dominant colors in the visual features (e.g., “brown,” “beige”). In another example, for “material” the model 108 detects material-related patterns in the visual features (e.g., “wood,” “fabric”). In some embodiments, after the model 108 generates metadata attribute value(s) 110, the system formats the output into a structured format suitable for indexing and retrieval. The extracted values are mapped to their corresponding user-defined fields. For example, Field: “color,” Value: [“brown”, “beige”]. Field: “material,” Value: [“wood”, “fabric”]. In some embodiments, the final output is structured in a format like JSON for storage in the metadata index, such as the following:

```
  {
    “color”: [“brown”, “beige”],
    “material”: [“wood”, “fabric”]
}
```

This process ensures the metadata generation model 108 produces accurate and relevant metadata tailored to user-defined fields and/or prompts.

In some embodiments, the metadata generation model 108 is trained, fine-tuned, and/or prompt-engineered to optimize its ability to extract metadata from digital assets. For example, if the model 108 is trained from scratch, the process involves dataset preparation, where the model 108 is trained on a multi-modal dataset containing pairs of images of objects or scenes and text descriptions or metadata labels corresponding to those images (e.g., “a red leather chair”). In some embodiments, the dataset includes diverse assets (e.g., chairs, tables, environments) and comprehensive annotations to generalize well. In some embodiments, the training objective includes a contrastive loss function (e.g., used in CLIP) to align image and text representations in a shared embedding space, where positive pairs (e.g., “red chair” text paired with an image of a red chair) are pulled closer in the embedding space. Negative pairs (e.g., “blue chair” text paired with an image of a red chair) are pushed apart. The trained model 108 learns to associate visual features (e.g., textures, shapes) with textual attributes (e.g., “wood,” “brown”), enabling the trained model 108 to generate metadata for unseen assets.

If using a pre-trained multi-modal model (e.g., CLIP, BLIP), fine-tuning can adapt the model to specific metadata generation tasks or domains. Various embodiments collect a smaller, focused dataset relevant to the assets (e.g., furniture, architectural elements). The dataset may include rendered images and custom metadata fields (e.g., “material,” “scene_type”). The pre-trained model 108 is fine-tuned using the domain-specific dataset while keeping the underlying image-text alignment capabilities intact. For example, the model 108 might be fine-tuned on metadata fields like “color” or “material” for furniture assets, allowing the model 108 to perform better on nuanced queries.

Prompt engineering is used to optimize how the model 108 interprets and responds to user prompts during metadata extraction: Prompts are carefully written to guide the model 108 in extracting relevant metadata. For example, instead of a generic prompt like “Describe this asset,” a detailed prompt like “Identify the primary materials used in this asset, such as wood, metal, or fabric” produces more accurate results. In some embodiments, examples of expected input-output pairs (e.g., few-shot examples) are provided in the prompt to show the model 108 what the desired output should look like. For example, the input may be “Materials in the asset.” The few-shot examples may be: Image of a chair-> “wood, fabric.” Image of a lamp-> “metal, glass.” Prompts are tested and iteratively refined to maximize the quality of the metadata output. For instance, adding domain-specific terminology (e.g., “grain texture” for wood) helps the model focus on specific features.

The metadata indexer 112 takes the metadata attribute value(s) 110 and organizes them into an index for efficient search and retrieval. The index links the metadata to unique identifiers for the digital assets, enabling users to query the system and retrieve relevant assets. For example, the metadata attribute value(s) 110 are stored in the index alongside the asset's unique identifier (asset 123):

```
{
  “asset_id”: “asset123”,
  “color”: [“brown”, “beige”],
  “material”: [“wood”, “fabric”],
  “scene_type”: “living room”
}.
```

When a user searches for “brown wooden chair,” the index matches the query to this metadata and identifies asset123 as a result, facilitating the retrieval of the corresponding asset. For instance, some embodiments incorporate natural language processing (NLP) and semantic similarity analysis. When a user submits a query (e.g., “brown wooden chair”), a query processor processes the query to extract keywords or embeddings. These are then compared to the stored metadata in the index. If the index stores embeddings for metadata (e.g., using a multi-modal model like CLIP), the query processor can calculate cosine similarity or other distance metrics between the query and metadata embeddings, identifying matches even when the query uses synonyms or related terms (e.g., matching “crimson” with “red”). Once a match is found, the index retrieves the associated asset identifier (e.g., asset123), which is then used to fetch the corresponding digital asset from its storage location. This process ensures precise and context-aware matching of queries to assets.

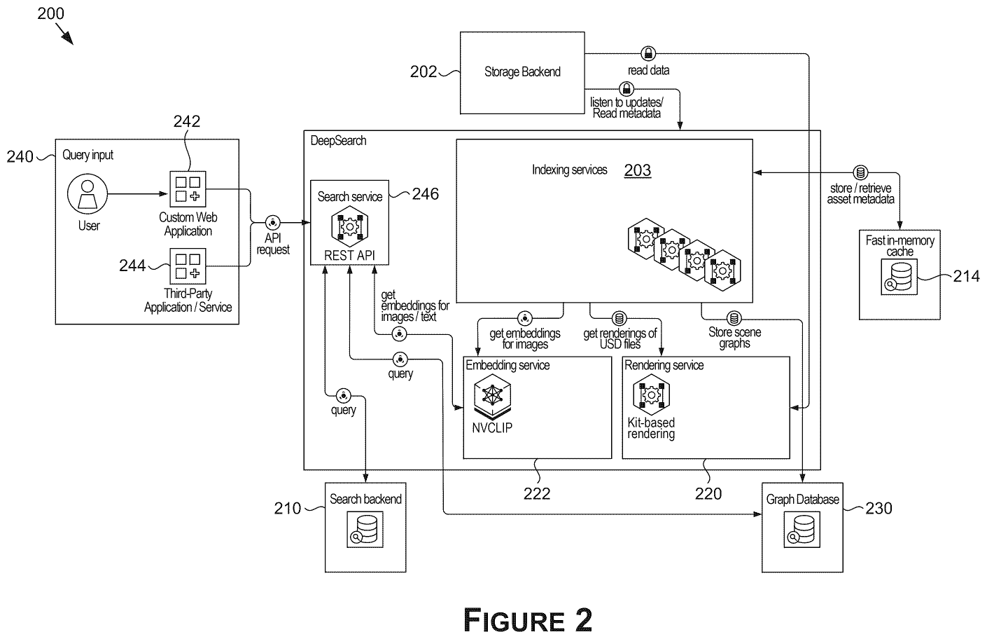

FIG. 2 illustrates an example search pipeline 200, according to some embodiments. In some embodiments, the indexing services 203 includes the indexing pipeline 100 of FIG. 1. In some embodiments, the indexing pipeline 100 occurs offline or before the pipeline 200. Accordingly, the pipeline 200 in some embodiments occurs at runtime after indexing has already occurred. At a first time, the query input 240 is received by the Search Service 246. In some embodiments, the query input 240 is issued from a Custom Web Application 242. This component corresponds to a web interface through which the user interacts with the system to submit queries. Alternatively, in some embodiments, the query input is issued from a Third-Party Application/Service 244. This is an external or third-party service that interacts with the system via API requests. The query input 240 captures the user's search request (e.g., searching for a specific 3D model or asset). The output is an API request to the Search Service (REST API) 246 for processing.

The Search Service (REST API) 246 is responsible for handling incoming API requests and coordinating the search across various components of the pipeline 200. The Search Service 246 distributes the query to other components like the Search Backend 210 (e.g., OpenSearch), the graph database 230, Embedding Service 222, and/or the Rendering Service 220 for further processing and responsively receives corresponding search results. For example, when a user submits a query 240, such as “3D models of red chairs,” the Search Service 246 receives the API request and coordinates the search. The Search Service 246 first sends the query 240 to the Search Backend 210 to retrieve any indexed metadata related to red chairs. If the search involves comparing visual features, the Search Service 246 forwards the query to the Embedding Service 222, which retrieves the relevant embeddings for both the text description “red chair” and stored 3D model embeddings (e.g., those embeddings stored to the fast in-memory cache 214). The results from these components are then aggregated and sent back to the user via the Search Service 246, which acts as the coordinator between all the services involved in processing the query.

The Search Backend (e.g., OpenSearch) 210 is the core search engine that stores searchable data such as metadata, embeddings, and/or asset-related information. The Search Backend 210 is queried directly by the Search Service 246. The Search Backend 210 returns the search results (e.g., asset metadata, embeddings, or graph data) to the Search Service 246 to be delivered back to a user device of the user.

The Embedding Service 222 (e.g., NVCLIP) generates and stores embeddings (vector representations) for assets, enabling efficient retrieval based on text or image queries. NVCLIP refers to a vision-language model that can process both text and images into a shared embedding space. The Embedding Service 222 receives a request from the Search Service 246 to retrieve or generate embeddings for images or text. The Embedding Service 222 sends the embeddings back to the Search Service 246, allowing for similarity-based search.

When a digital asset (e.g., a 3D model or image) is retrieved from the Storage Backend 202 and processed by services such as the Rendering Service 220, the Rendering Service 220generates visual data like thumbnails or previews. Once the visual or textual data is generated and processed, the Embedding Service 222 encodes these data into embeddings-numeric vectors that represent the asset in a way that allows for similarity search and efficient retrieval. These embeddings are passed back through the Indexing Services 203 and stored in the Search Backend (e.g., OpenSearch) 210, where they can be queried later during the search process, such as via query 240.

Fast In-Memory Cache 214 (e.g., REDIS) is used as a fast in-memory cache for storing and managing search tasks, indices from the indexing services 203, asset metadata, and/or processing tasks. The Graph Database 230 (e.g. Neo4j) stores and manages the graph-based data that represents relationships between digital assets, such as spatial relationships, dependencies, or hierarchical structures. The Rendering Service 220 (e.g., the asset renderer 102 of FIG. 1) generates visual representations (e.g., thumbnails or rendered images) from USD files or 3D models. The Rendering Service 220 receives a USD file or 3D model to be rendered into an image or visual output. At the output, the Rendering Service 220 sends the rendered images to the Embedding Service 222 for embedding generation and subsequent storage in the Search Backend.

As illustrated in FIG. 2, the Rendering Service 220 includes kit-based rendering functionality. Developers can select and configure various rendering modules, such as ray tracing, path tracing, or real-time rendering, depending on the use case and performance needs. Kit-based rendering supports the integration of custom shaders, materials, and/or physics simulations, making Kit-based rendering ideal for highly specific workflows like architectural visualization, digital twins, and virtual production. In an illustrative example, when a USD file is passed through the kit-based rendering service 220, the kit-based rendering service 220uses this framework to generate thumbnails or high-quality previews of the scene, such as traffic cones or furniture in a 3D room. This flexible approach allows developers to select the appropriate rendering pipeline based on the desired output (thumbnails, real-time previews, or photorealistic renders).

The Indexing Services 203 are responsible for preparing, indexing, and managing asset data, including metadata extraction, graph building, and embedding generation. For example, as described with respect to FIG. 1, the metadata indexer 112 indexes the metadata attribute value(s) 110 of FIG. 1. In some embodiments, a Non-Rendering Tasks Scheduler manages other tasks like metadata processing or graph building, an Asset Graph Service (AGS) stores graph data for assets, an Asset Graph Builder constructs graph structures from asset relationships. In other words, the input to the indexing services 203 is the receipt of asset data (such as USD files) from the Storage Backend 202. The output is indexed metadata, generated embeddings, and/or stored graph data in the Search Backend 210 and Graph Database 230 for later querying. The Storage Backend 202 (e.g., AWS S3, Enterprise Nucleus) is the source of raw digital assets such as USD files or 3D models.

In some embodiments, the graph database 230 stores graph data that captures relationships between objects, metadata, and/or spatial information in a digital asset. At search or query time, a user can submit an Asset Graph Service (AGS) query, which gets forwarded to an asset graph service, which responsively retrieves, from the graph database 230, one or more relevant graph data structures dependent on the AGS query. Processing the AGS query using the asset graph service involves looking up relationships, properties, or metadata about assets stored in the graph database 230, such as relationships between digital assets. For example, the query input 240 may include “all chairs within 2 meters of any table in the current scene(s).” This query is sent to the asset graph service to search for relationships between chairs and tables based on spatial proximity. The asset graph service queries the graph database 230 (which contains the asset graph) to locate nodes (chairs and tables) and analyze the edges (which represent the spatial relationships). The system looks for any chair node that has an edge (spatial relationship) to a table node where the distance is less than or equal to 2 meters. The result would be a list of chairs in the scene(s) that meet this condition, possibly returned with details such as asset IDs or positions.

In an example illustration of how the asset graph service works when an in-scene search query is issued, the query input 240 may be “all red chairs in this living room scene.” The search service 246 responsively queries the asset graph service to identify all objects in the scene categorized as chairs. The asset graph service analyzes the scene's graph structure to find all chair nodes and retrieves their spatial relationships (e.g., where each chair is positioned in the living room). Simultaneously, the search service 246 retrieves the embeddings for each chair from the Search Backend 210, which contain visual information like the color of each chair. The search service 246 combines the graph data (spatial relationships) with the embedding information (color attributes) to filter out any chairs that are not red. The graph data helps the search service 246 to understand the positions of the chairs, while the embeddings help refine the query based on visual attributes. The result is a list of red chairs in the living room scene, including their positions within the scene. The user receives the filtered results based on both the scene's graph structure and the embeddings.

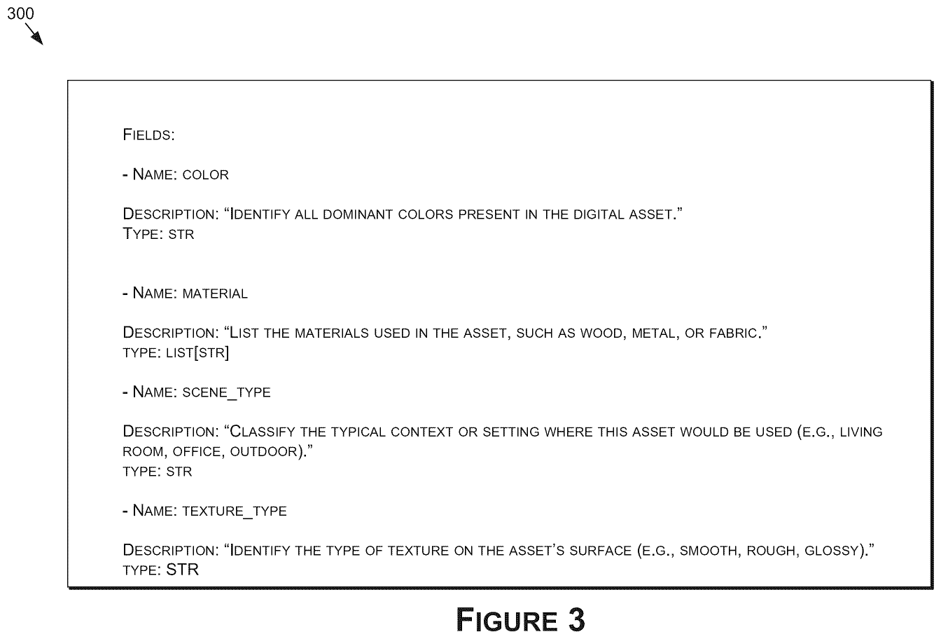

FIG. 3 is a schematic diagram illustrating the contents of a YAML file 300, according to some embodiments. A YAML file is a structured, human-readable file format used to define configuration data. The YAML file 300 contains metadata configuration fields that guide the system in generating specific metadata values for digital assets. Here's a detailed description: The YAML file 300 contains a list of fields (“color,” “material,” “scene_type,” and “texture_type”) representing the metadata attributes the user wants the model to extract. Each field is named to identify the type of metadata (e.g., “color”). In some embodiments, each field represents the user-defined field(s) 106 of FIG. 1. Each field has a corresponding description, which serves as a textual instruction or “prompt” that guides the metadata generation model (e.g., the metadata generation model 108 of FIG. 1) in extracting the values for that field. In some embodiments, such “description” represents what is output by the metadata prompt generator 104 of FIG. 1. The descriptions explain, in natural language, what kind of information the model should extract (e.g., “Identify all colors present in the asset”). Users can define custom fields that align with their specific use cases. For example, a user might add a field like “scene_type” with a description such as “Determine the typical room where this asset is used.”

In some embodiments, YAML files also include parameters such as thresholds, priorities, or data types to provide additional control over how metadata is generated. These parameters act as instructions or constraints for the system to follow during processing. The “threshold” defines the minimum confidence level required for the system to include a prediction in the output. For example, if the model predicts “red” with a confidence of 0.6 and the threshold is 0.7, the system will exclude “red” from the final metadata values for the “color” field. “Priority” specifies how critical a metadata field is. Fields with higher priority (e.g., “high”) may receive additional processing steps, such as using more precise models or performing retries if predictions are ambiguous. For example, “color” is marked as high-priority, so the system ensures accurate extraction even if more computation time is required. “Data type” helps instruct the system on the expected format of the output for the field (e.g., list, string, Boolean). For example, for a list, for “color,” the model outputs multiple values (e.g., [“brown”, “beige”]). For String, and for “scene_type,” the model outputs a single value (e.g., “living room”).

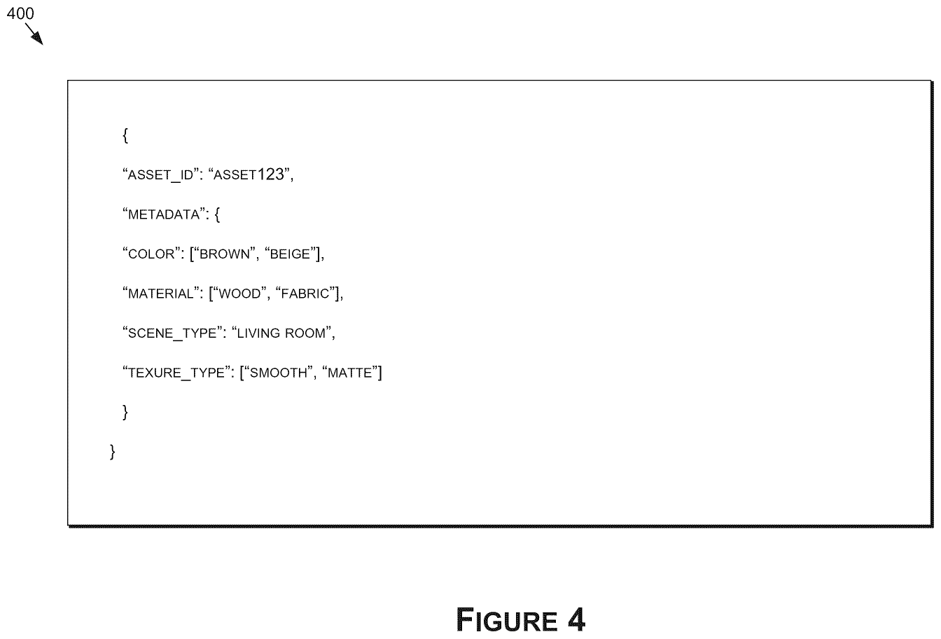

FIG. 4 is a schematic diagram of extracted metadata attribute-value pairs, according to some embodiments. In some embodiments, each of the values of the attribute-value pairs in FIG. 4 represent the metadata attribute value(s) 110 of FIG. 1. Specifically, FIG. 4 illustrates a JSON metadata output, which is a structured data format that represents the metadata attribute values extracted by the model. The model organizes the information into key-value pairs where keys (e.g., “color,” “material”) correspond to the metadata fields defined (e.g., in the YAML file 300 of FIG. 3). The “values” contain the extracted metadata attribute values (e.g., “red,” “wood”) for each field. A unique identifier (“asset123”) links this metadata to the specific digital asset.

In some embodiments, the process of converting model predictions (e.g., the metadata attribute value(s) 110) into a structured JSON output involves several steps, including post-processing, mapping, and formatting. For example, the metadata generation model 108 model processes the input (rendered images and prompts) and generates predicted metadata values for the specified fields. These predictions may be in the form of text labels (e.g., “brown,” “wood”), lists of values (e.g., [“brown”, “beige”]), and/or confidence scores for each prediction (e.g., {“brown”: 0.95, “beige”: 0.80}).

In some instances, the raw predictions from the model may need to be cleaned or filtered to ensure consistency and usability. Filtering remove predictions with low confidence scores (e.g., below a threshold of 0.7). Normalization standardizes outputs (e.g., “Brown”-> “brown” for case consistency). If multiple predictions are made, some embodiments rank them based on confidence scores or relevance. Some embodiments uses the user-defined fields (e.g., from a YAML file) to map the model's predictions to the correct metadata attributes. Each field (e.g., “color”) acts as a key, and the corresponding model predictions become the values. Some embodiments organize the mapped metadata fields and their values into a structured JSON object. For example, in some embodiments this includes adding an asset identifier to link the metadata to the original digital asset and structuring metadata fields as key-value pairs within a nested JSON object. In some embodiments, the metadata indexer 12 stores the finalized JSON object in a metadata index for future search and retrieval and delivers the index to the user device via an API, UI, or file export.

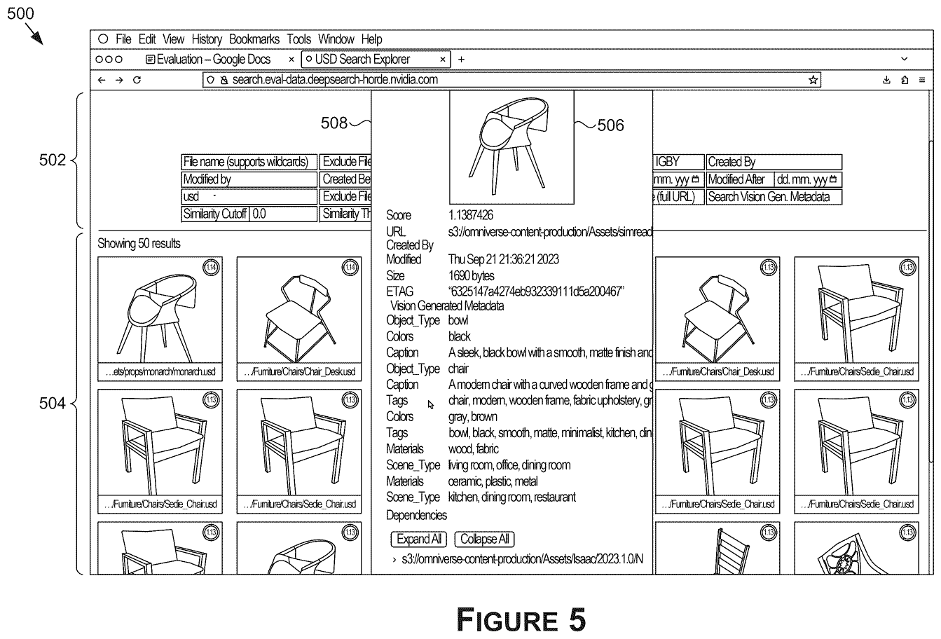

FIG. 5 is a screenshot of an example user interface page 500 illustrating digital asset search results (e.g., 504) that are surfaced in response to processing a query 502, according to some embodiments. In some embodiments, the user interface page 500 is provided as part of the search pipeline 200 of FIG. 2. For example, in some embodiments, the query 502 represents the query input 240 of FIG. 2. At a first time, particular embodiments receive and process the query 502 “I need a brown modern wooden chair with gray fabric upholstery.” The search results, including search result 504, are responsively provided to the page 500. The search result 504 includes an image 506 of a digital asset along with its metadata 508, which include attribute-value pairs (e.g., “score: 1.1387426” and “object_type: chair”). In some embodiments, the metadata 508 represents or includes the metadata attribute value(s) 110 and/or the data indexed by the metadata indexer 112 of FIG. 1.

The query processor returns the search results by leveraging the metadata index and one or more of natural language processing (NLP), semantic matching, and/or ranking algorithms to match the query with the indexed metadata. For example, a tokenizer may first tokenize or split the query 502 into key components: Object type: “chair, “Attributes: “brown,” “modern,” “wooden,” “gray fabric upholstery.” Some embodiments use NLP techniques (e.g., embeddings or ontologies) to account for synonyms and related terms. For example, “modern” might expand to include “sleek,” “contemporary.” In another example, “wooden” might include “wood frame.”

In some embodiments, the query processor assigns weights to different terms in the metadata 508 based on their relevance to terms in the query 502. For example, “chair” is given high weight as the term specifies the object type and “gray fabric upholstery” is given moderate weight as a specific detail. The query processor searches the metadata index, which contains pre-generated metadata 508 for each digital asset. The system matches the query terms (e.g., “chair,” “brown,” “modern”) with the metadata 508 stored in the index: Object Type matches “chair.” Tags matches “modern,” “wooden frame,” “fabric upholstery,” “gray,” and “brown.” Materials matches “wood” and “fabric.” Colors matches “gray” and “brown.” Various embodiments then calculate semantic similarity between the query and indexed metadata using techniques like cosine similarity or deep embeddings (e.g., CLIP embeddings). For example, a vector representation of “brown modern wooden chair with gray fabric” is compared to a vector representation of “a modern chair with a curved wooden frame and gray fabric.” The similarity score is 1.1387 (indicating a strong match). Various embodiments then filter out irrelevant results by eliminating Non-matching object types, eliminating results with object type (e.g., “bowl” is deprioritized because the query specifies “chair”). Attribute filters may also be applied. Results missing critical attributes (e.g., “brown” or “gray fabric upholstery”) are removed or given lower scores.

Various embodiments then rank the remaining results based on relevance to the query 502. Scoring factors may include any suitable factors, such as exact matches between terms of query 502 and metadata 508, semantic matches, and/or metadata quality (results with richer, more detailed metadata (e.g., captions and tags) are prioritized). The system formats and returns the top-ranked result(s) to the user.

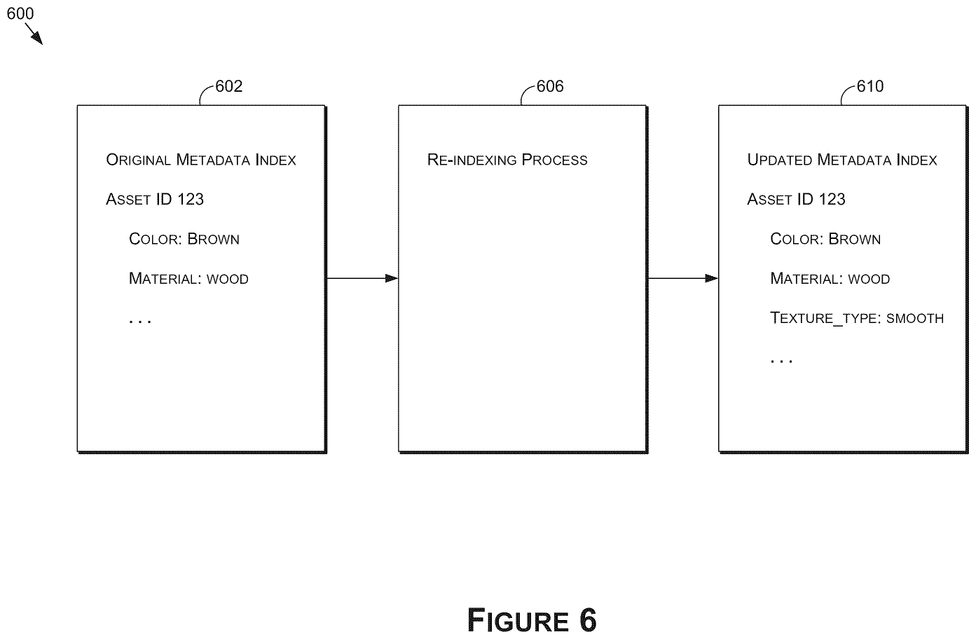

FIG. 6 is a block diagram illustrating how a metadata index is re-indexed, according to some embodiments. The original metadata index 602 includes asset ID 123 representing a particular digital asset, along with attribute-value pairs “color: brown,” and “material: wood.” The re-indexing trigger 604 includes receiving an indication that the user has updated a YAML configuration file to include a new metadata field “texture_type” and/or a prompt “determine the surface texture of the asset.” This triggers a re-indexing process 606 because the index must now populate the new “texture_type” field for all existing assets. During the re-indexing process 606, particular embodiments first retrieve the digital asset (e.g., the 3D model) for asset123 from its storage location. The original asset data (e.g., rendered images) is needed to extract additional metadata for the new field. The multi-modal metadata generation model 108 processes the digital asset again in the re-indexing process 606, using the updated YAML configuration file to extract both existing fields (“color” and “material”) for validation or refinement and the new field (“texture_type”) and/or new prompt for additional metadata extraction. Continuing with the re-indexing process 606, the model then predicts that the new “texture-type” attribute value is “smooth.” The new metadata is merged with the original metadata in the index, creating an updated metadata index 610 for asset123. The updated metadata index 610 is updated to include the new “texture_type” field and corresponding value “smooth” while retaining the original fields. The updated index 610 now includes the “texture_type” field and value, allowing users to query for specific surface textures (e.g., “smooth wooden chair”). This process ensures that the index remains comprehensive, up-to-date, and capable of handling new query requirements.

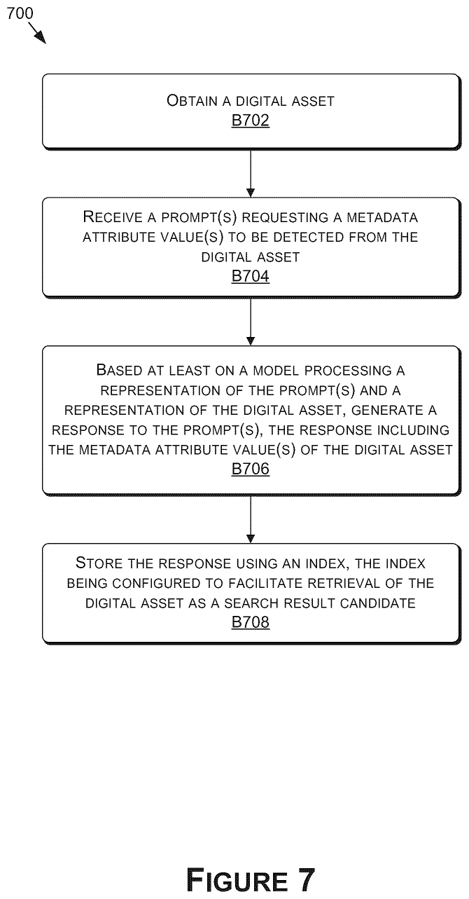

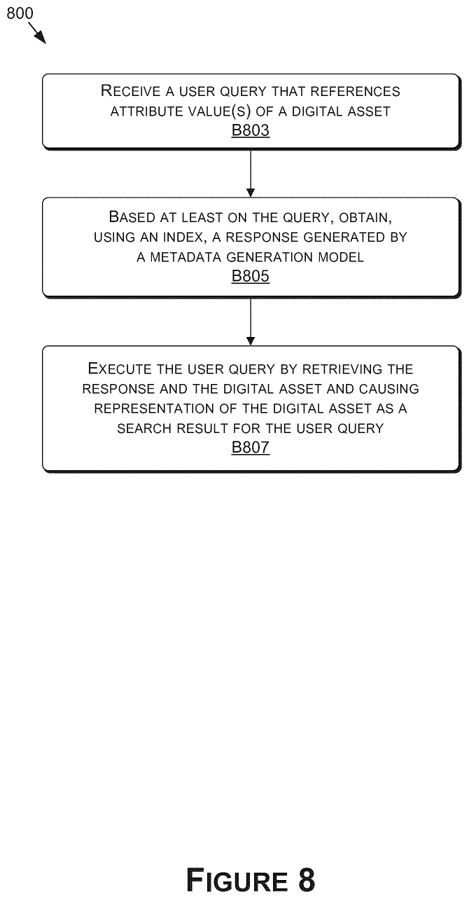

FIGS. 7 through 8 are flow diagrams of example methods. Each block of methods 700 and/or 800 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 700 and/or 800 is described, by way of example, with respect to the pipeline 100 of FIG. 1 and/or the pipeline 200 of FIG. 2. However, these processes may additionally or alternatively be executed by any one system, or any combination of systems, including, but not limited to, those described herein.

FIG. 7 is a flow diagram of an example process 700 for building a metadata index that describes attribute values of a digital asset, according to some embodiments. In some embodiments, the process 700 represents or includes the indexing pipeline 100 of FIG. 1. Per block 702, some embodiments first obtain a digital asset. A “digital asset” (or “asset”) refers to any piece of content or data that exists in a digital format and is stored electronically. For example, a digital asset can include a 3D model (e.g., that includes a tetrahedral mesh), an image (e.g., a digital picture), a video (or individual frames that makeup the video), scene data, and/or a file (e.g., USD files) that represent objects or entities in a virtual environment. Digital assets may be associated with various types of metadata (such as visual attributes, spatial relationships, material properties) and can be indexed, searched, retrieved, and manipulated based on specific parameters or conditions.

Per block 704, some embodiments receive one or more prompts (e.g., generated by the metadata prompt generator 104 and/or the user-defined field(s) 106) requesting one or more metadata attribute values to be associated with, and subsequently capable of being referenced by (e.g., identified, classified, or determined) the digital asset. For example, such one or more prompts may include each of the “description” values in FIG. 3. A “prompt” is any form of input-structured or unstructured—that defines the scope, type, and/or criteria for the output response to be generated, extracted, or processed by a system. The prompt typically requests, either explicitly or implicitly, the one or more metadata attribute values to be associated with a digital asset. For example, a prompt can be or include: an natural language instruction that explicitly requests the system to detect an attribute value from a digital asset (e.g., “Identify the dominant colors in the asset”), a user-defined field that specifies desired metadata attributes (e.g., “color,” “material”) and is an implicit signal for a model to detect corresponding metadata attribute value(s), and/or predefined templates or structured inputs (e.g., YAML configurations) that direct the system on what to process or extract. For example, each of the “name” values (e.g., “color,” “material,” etc.) and the “descriptions” are different prompts in some embodiments. In some embodiments, the one or more prompts include one or more user-specified metadata attributes of a digital asset (e.g., the name “color” of the YAML file 300 of FIG. 3).

Some embodiments obtain a configuration file (e.g., a YAML file, a JSON file, an XML file, an INI file, or protocol buffers) that includes a user-defined field representing a metadata attribute (e.g., “color”) associated with the one or more metadata attribute values (e.g., “red”) of the digital asset. The configuration file may also include the one or more prompts (e.g., each of the “descriptions” indicated in FIG. 3) that include natural language characters input by a user. In some embodiments, the “one or more prompts” a first natural language command or question issued by a user and/or a second natural language question or command issued by a language model agent (e.g., an AI-agent), as described with respect to the metadata prompt generator 104 of FIG. 1.

Per block 706, based at least on a model (e.g., the metadata generation model 108) processing a representation of the one or more prompts and a representation of the digital asset, some embodiments (e.g., the model 108 of FIG. 1) generate a response to the one or more prompts. The response includes the metadata attribute value(s) (e.g., the metadata attribute value(s) 110 of FIG. 1) of the digital asset. FIG. 4 or metadata attribute value(s) 110 of FIG. 1 represents an example of a response. A “representation” refers to the payload (e.g., a digital asset, prompt, or user-defined field) itself or other indicator that represents the payload, such as a vector, hash, or other values that represents the payload. Some embodiments, such as the asset renderer 102, and/or the metadata prompt generator 104, provide respective representations of the one or more user-defined fields, the one or more prompts, and/or the digital asset as input into the model such that the model generates the response to the one or more prompts.

Some embodiments render a plurality of images of the digital asset. Each image represents a unique angle of the digital asset such that a plurality of representations of the plurality of image are used by the model as input to generate the response, as described, for example with respect to the asset renderer 102 of FIG. 2. For example, some embodiments place virtual cameras at predefined positions around the asset in a simulated 3D environment. Each camera captures the asset from a unique angle, such as front, side, top, and perspective views, ensuring comprehensive visual coverage of the asset's geometry and appearance. The rendering process includes applying lighting, materials, and textures to the asset to ensure realistic representations. These images are then pre-processed into a plurality of representations, such as feature embeddings or pixel arrays, which are fed into the model as input. By combining the visual information from multiple angles, the model generates a detailed and accurate response that captures the asset's key attributes, such as color, material, and texture from most or all angles.

In some embodiments, the response indicated in block 706 comprises a structured data format with a plurality of metadata attributes of the digital asset that are each mapped to a corresponding metadata attribute value. For example, such structured data format may include the JSON file output as represented in FIG. 4.

Per block 708, some embodiments store the response using an index, where the index is configured to facilitate retrieval of the digital asset as a search result candidate. For example, after the metadata generation model 108 processes the digital asset (e.g., images rendered from multiple angles) along with user-defined fields or prompts, some embodiments assign or retrieve a unique identifier (e.g., asset_id: asset123) for the digital asset, which links the metadata to the actual asset stored in the repository. In some embodiments, the system stores the metadata as key-value pairs in an index, where keys represents metadata fields (e.g., “color,” “material,” “tags”) and values represent metadata attribute values (e.g., [“brown”, “wood”]). The index also includes the asset identifier to facilitate asset retrieval. The index is designed for efficient searching, using a structure such as an inverted index (links metadata attributes to asset identifiers for quick lookups) or a vector index (stores embeddings of metadata (e.g., from a multi-modal model) to enable semantic searches). During a search, the system matches user queries (e.g., “brown wooden chair”) with the metadata stored in the index. The matching result includes the asset identifier (e.g., asset123), which is used to retrieve and display the corresponding asset from the repository.

Subsequent to executing a query, some embodiments receive a second prompt requesting a second metadata attribute value (e.g., the “texture_type” attribute of FIG. 6) to be associated with the digital asset, which can be later used to reference (e.g., identify, find, classify, etc.) the digital asset. Some embodiments then generate (e.g., via the re-indexing process 606 of FIG. 6), based at least on the model processing a second representation of the second prompt and the representation of the digital asset, a second response to the second prompt. Particular embodiments then update the index by storing the second response using the index. Examples of such functionality as described with respect to FIG. 6, where the response represents the original metadata index 602 and the updated metadata index 610 represents the second response.

FIG. 8 is a flow diagram of an example of a search process 800 for executing a user query that references attribute value(s) of a digital asset, according to some embodiments. In some embodiments, the process 800 represents or includes the search pipeline 200 of FIG. 2. Per block 803, some embodiments receive a user query that references one or more attribute values of a digital asset. For example, such user query may represent the query input 240 of FIG. 2 or the query 502 of FIG. 5. In some embodiments, the process 800 occurs subsequent to the process 700 of FIG. 7 and the attribute value(s) and digital asset indicated in FIG. 8 is the same attribute value(s) and digital asset referenced in FIG. 7.

Per block 805, based at least on the user query, some embodiments obtain, using an index, a response generated by a metadata generation model (e.g., 108 of FIG. 1). For example, some embodiments use the index to obtain a response generated by the metadata generation model by searching for metadata attribute values that match a user's query. The index stores the metadata generated by the model, organized as key-value pairs where the keys are metadata fields (e.g., “color,” “material”) and the values are linked to unique asset identifiers. When a query is issued (e.g., “brown wooden chair”), the system processes the query, matches its terms with the metadata stored in the index (e.g., using exact matches or semantic similarity), and retrieves the corresponding asset identifiers. These identifiers are then used to fetch and present the stored response (e.g., metadata values, associated images, and descriptions) generated during the initial indexing process.

Per block 807, some embodiments execute the user query by retrieving the response and the digital asset and cause presentation of the digital asset as a search result for the user query. For example, some embodiments execute the user query by first analyzing the query to extract relevant terms or embeddings (e.g., “brown wooden chair”). Some embodiments then searches the index, which stores metadata generated by the model, to identify matching metadata fields and their associated asset identifiers. Using these identifiers, the system retrieves the corresponding digital assets (e.g., images, 3D models) and their metadata from the storage or database. Finally, the system presents the digital asset as a search result, including its visual representation (e.g., an image or thumbnail) and associated metadata (e.g., “color: brown,” “material: wood”) to the user device, ensuring that the result aligns with the intent of the query.

Some embodiments engage in “semantic” functionality in the process 800. For instance, aspects convert at least one of the digital asset or the response to a first embedding, the first embedding being a vector representation of a word or phrase that captures meaning in relation to other words or phrases. Some embodiments store the first embedding using the index. Based at least on accessing the first embedding using the index and determining a distance between the first embedding and a second embedding representing a user query. Some embodiments execute the user query by retrieving the digital asset and causing presentation of the digital asset as a search result for the user query. In some embodiments, the first embedding is a high-dimensional vector capturing the semantic meaning of the asset in relation to other assets. For example, a metadata description like “a modern chair with a curved wooden frame and gray fabric” is processed by a multi-modal model (e.g., CLIP) to generate a vector embedding. This embedding is stored in the index alongside the asset identifier. When a user query (e.g., “gray wooden modern chair”) is issued, the query is converted into a second embedding using the same model. The system determines the similarity between the first and second embeddings by calculating a distance metric (e.g., cosine similarity). If the embeddings are close or within a threshold distance, the system retrieves the corresponding digital asset (e.g., a chair model) and presents the digital asset as a search result.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc.of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model or version, instance, or agent-maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant-such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve-using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents-which may result in a lack of context, factual correctness, language accuracy, etc.-graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database.

In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features-such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using-plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated —e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources-such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more embodiments described below may be combined with one or more other embodiments. In an example embodiment, one or more processors comprising one or more processing units to: obtain a digital asset; obtain one or more prompts requesting one or more metadata attribute values to be associated with the digital asset; based at least on a model processing a representation of the one or more prompts and a representation of the digital asset, generate a response to the one or more prompts, the response including the one or more metadata attribute values of the digital asset; and store the response using an index configured to facilitate retrieval of the digital asset as a search result candidate.

In some embodiments, the one or more processing units are further to: obtain a configuration file that includes: a user-defined field representing a metadata attribute associated with the one or more metadata attribute values of the digital asset; and the one or more prompts that include natural language characters input by a user, and wherein the model processes the configuration file to generate the response that includes the one or more metadata attribute values.

In some embodiments, the one or more processing units are further to: render a plurality of images of the digital asset, each image of the plurality of images representing a unique viewing angle of the digital asset, and wherein a plurality of representations of the plurality of images are used by the model as input to generate the response.

In some embodiments, the one or more processing units are further to: receive a user query that references the one or more metadata attribute values of the digital asset; based at least on the user query, obtain, using the index, the response; and based at least on the generating of the response, executing the user query by retrieving the response and the digital asset and causing presentation of the digital asset as a search result for the user query.

In some embodiments, the one or more processing units are further to: convert at least one of the digital asset to a first embedding, the first embedding being a vector representation of a word or phrase that semantically represents the digital asset; store the first embedding using the index; and based at least on accessing the first embedding using the index and determining a distance between the first embedding and a second embedding representing a user query, execute the user query by retrieving the digital asset and causing presentation of the digital asset as a search result for the user query.

In some embodiments, the one or more processing units are further to: subsequent to executing a user query, receive a second prompt requesting a second metadata attribute value to be associated with the digital asset; generate, based at least on the model processing a second representation of the second prompt and the representation of the digital asset, a second response to the second prompt; and update the index by storing the second response using the index.

In some embodiments, the response comprises a structured data format with a plurality of metadata attributes of the digital asset that are mapped to a corresponding metadata attribute value.

In some embodiments, the one or more prompts include at least one of a first natural language command or question issued by a user or a second natural language command or question issued by a language model agent.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; a system incorporating one or more virtual machines (VMs); a system implemented at least partially in a data center; or a system implemented at least partially using cloud computing resources.

In an embodiment, a data center system comprises a plurality of computing nodes, wherein two or more computing nodes of the plurality of computing nodes comprise one or more graphics processing units (GPUs) to: obtain one or more user-defined fields representing one or more metadata attributes associated with a digital asset; receive one or more prompts requesting, in natural language, one or more metadata attribute values of the one or more metadata attributes to be associated with the digital asset; provide at least one of: a representation of the one or more user-defined fields, a representation of the one or more prompts, or a representation of the digital asset as input into a model, wherein the model generates a response to the one or more prompts, the response including the one or more metadata attribute values of the digital asset; and store the response using an index, the index being configured to facilitate retrieval of data for a query associated with the digital asset.

In some embodiments, the one or more GPUs are further to: obtain a configuration file that includes: the one or more user-defined fields; and the one or more prompts, wherein the model processes the configuration file to generate the response that includes the one or more metadata attribute values.

In some embodiments, the one or more GPUs are further to: render a plurality of images of the digital asset, each image, of the plurality of images, representing a unique viewing angle of the digital asset, and wherein a plurality of representations of the plurality of images are used by the model as input to generate the response.

In some embodiments, the one or more GPUs are further to: receive a user query that references the one or more metadata attribute values of the digital asset; based at least on the user query, obtain, using the index, the response; and based at least on the model generating the response, executing the user query by retrieving the response and the digital asset and causing presentation of the digital asset as a search result for the user query.

In some embodiments, the one or more GPUs are further to: convert at least one of the digital asset or the response to a first embedding, the first embedding being a vector representation of a word or phrase that captures meaning in relation to other words or phrases; store the first embedding using the index; and based at least on accessing the first embedding using the index and determining a distance between the first embedding and a second embedding representing the user query, executing the user query by retrieving the digital asset and causing presentation of the digital asset as a search result for the user query.

In some embodiments, the one or more GPUs are further to: subsequent to executing a user query, receive a second prompt requesting a second metadata attribute value to be associated with the digital asset; generate, based at least on the model processing a second representation of the second prompt and the representation of the digital asset, a second response to the second prompt; and update the index by storing the second response using the index.

In some embodiments, the response comprises a structured data format with a plurality of metadata attributes of the digital asset that are mapped to a corresponding metadata attribute value.

In some embodiments, the one or more prompts include at least one of a first natural language command or question issued by a user or a second natural language command or question issued by a language model agent.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models; or a system incorporating one or more virtual machines (VMs).

In an embodiments, a method comprises: obtaining one or more user-specified metadata attributes of a digital asset; processing, by a multi-modal model, a representation of the digital asset and a representation of the one or more user-specified metadata attributes to generate a response comprising one or more metadata attribute values corresponding to the one or more user-specified metadata attributes; storing the response in a structured data format; and indexing the response in the structured data forma to facilitate retrieval of the digital asset as a search result candidate.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using one or more large language models (LLMs); a system for generating synthetic data using one or more vision language models (VLMs); a system for generating synthetic data using one or more multi-modal language models: a system incorporating one or more virtual machines (VMs); a system implemented at least partially in a data center; or a system implemented at least partially using cloud computing resources.

What is claimed is:

1. One or more processors comprising one or more processing units to:
obtain a digital asset;
obtain one or more prompts requesting one or more metadata attribute values to be associated with the digital asset;
based at least on a model processing a representation of the one or more prompts and a representation of the digital asset, generate a response to the one or more prompts, the response including the one or more metadata attribute values of the digital asset; and
store the response using an index configured to facilitate retrieval of the digital asset as a search result candidate.

2. The one or more processors of claim 1, wherein the one or more processing units are further to:
obtain a configuration file that includes:
a user-defined field representing a metadata attribute associated with the one or more metadata attribute values of the digital asset; and
the one or more prompts that include natural language characters input by a user, and wherein the model processes the configuration file to generate the response that includes the one or more metadata attribute values.

3. The one or more processors of claim 1, wherein the one or more processing units are further to:
render a plurality of images of the digital asset, each image of the plurality of images representing a unique viewing angle of the digital asset, and wherein a plurality of representations of the plurality of images are used by the model as input to generate the response.

4. The one or more processors of claim 1, wherein the one or more processing units are further to:
receive a user query that references the one or more metadata attribute values of the digital asset;
based at least on the user query, obtain, using the index, the response; and
based at least on the generating of the response, executing the user query by retrieving the response and the digital asset and causing presentation of the digital asset as a search result for the user query.

5. The one or more processors of claim 4, wherein the one or more processing units are further to:
convert at least one of the digital asset to a first embedding, the first embedding being a vector representation of a word or phrase that semantically represents the digital asset;
store the first embedding using the index; and
based at least on accessing the first embedding using the index and determining a distance between the first embedding and a second embedding representing a user query, execute the user query by retrieving the digital asset and causing presentation of the digital asset as a search result for the user query.

6. The one or more processors of claim 1, wherein the one or more processing units are further to:
subsequent to executing a user query, receive a second prompt requesting a second metadata attribute value to be associated with the digital asset;
generate, based at least on the model processing a second representation of the second prompt and the representation of the digital asset, a second response to the second prompt; and
update the index by storing the second response using the index.

7. The one or more processors of claim 1, wherein the response comprises a structured data format with a plurality of metadata attributes of the digital asset that are mapped to a corresponding metadata attribute value.

8. The one or more processors of claim 1, wherein the one or more prompts include at least one of a first natural language command or question issued by a user or a second natural language command or question issued by a language model agent.

9. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models;
a system incorporating one or more virtual machines (VMs);
a system implemented at least partially in a data center; or
a system implemented at least partially using cloud computing resources.

10. A data center system comprising a plurality of computing nodes, wherein two or more computing nodes of the plurality of computing nodes comprise one or more graphics processing units (GPUs) to:
obtain one or more user-defined fields representing one or more metadata attributes associated with a digital asset;
receive one or more prompts requesting, in natural language, one or more metadata attribute values of the one or more metadata attributes to be associated with the digital asset;
provide at least one of: a representation of the one or more user-defined fields, a representation of the one or more prompts, or a representation of the digital asset as input into a model, wherein the model generates a response to the one or more prompts, the response including the one or more metadata attribute values of the digital asset; and
store the response using an index, the index being configured to facilitate retrieval of data for a query associated with the digital asset.

11. The data center system of claim 10, wherein the one or more GPUs are further to:
obtain a configuration file that includes:
the one or more user-defined fields; and
the one or more prompts, wherein the model processes the configuration file to generate the response that includes the one or more metadata attribute values.

12. The data center system of claim 10, wherein the one or more GPUs are further to:
render a plurality of images of the digital asset, each image, of the plurality of images, representing a unique viewing angle of the digital asset, and wherein a plurality of representations of the plurality of images are used by the model as input to generate the response.

13. The data center system of claim 10, wherein the one or more GPUs are further to:
receive a user query that references the one or more metadata attribute values of the digital asset;
based at least on the user query, obtain, using the index, the response; and
based at least on the model generating the response, execute the user query by retrieving the response and the digital asset and cause presentation of the digital asset as a search result for the user query.

14. The data center system of claim 13, wherein the one or more GPUs are further to:
convert at least one of the digital asset or the response to a first embedding, the first embedding being a vector representation of a word or phrase that captures meaning in relation to other words or phrases;
store the first embedding using the index; and
based at least on accessing the first embedding using the index and determining a distance between the first embedding and a second embedding representing the user query, executing the user query by retrieving the digital asset and causing presentation of the digital asset as a search result for the user query.

15. The data center system of claim 10, wherein the one or more GPUs are further to:
subsequent to executing a user query, receive a second prompt requesting a second metadata attribute value to be associated with the digital asset;
generate, based at least on the model processing a second representation of the second prompt and the representation of the digital asset, a second response to the second prompt; and
update the index by storing the second response using the index.

16. The data center system of claim 10, wherein the response comprises a structured data format with a plurality of metadata attributes of the digital asset that are mapped to a corresponding metadata attribute value.

17. The data center system of claim 10, wherein the one or more prompts include at least one of a first natural language command or question issued by a user or a second natural language command or question issued by a language model agent.

18. The data center system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models; or
a system incorporating one or more virtual machines (VMs).

19. A method comprising:
obtaining one or more user-specified metadata attributes of a digital asset;
processing, by a multi-modal model, a representation of the digital asset and a representation of the one or more user-specified metadata attributes to generate a response comprising one or more metadata attribute values corresponding to the one or more user-specified metadata attributes;
storing the response in a structured data format; and
indexing the response in the structured data forma to facilitate retrieval of the digital asset as a search result candidate.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using one or more large language models (LLMs);
a system for generating synthetic data using one or more vision language models (VLMs);
a system for generating synthetic data using one or more multi-modal language models;
a system incorporating one or more virtual machines (VMs);
a system implemented at least partially in a data center; or
a system implemented at least partially using cloud computing resources.
